(19) United States
(12) Patent Application Publication
(10) Pub. No.: US 2009/0310139 A1
(43) Pub. Date: Dec. 17, 2009

(54) Detection of Substances

(76) Inventor: Howard Slater, Somerset (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/307,026

(22) PCT Filed: Jul. 5, 2007
(86) PCT No.: PCT/GB07/50380

§ 371 Date: Jul. 1, 2009

(30) Foreign Application Priority Data
Jul. 5, 2006 (GB) 0613284.9

(51) Int. Cl. G01N 21/55

(52) U.S. Cl. 356/445

(57) ABSTRACT

A method for detection of biological materials is described, comprising allowing a substance to be detected to bind to a ligand provided on the surface of a material within which light can undergo attenuated total internal reflection; transmitting light within the material; and detecting any bound substances by a change in light within or adjacent the material. Apparatus for performing the method is also described. The biological materials may be nucleic acids, or an antibody/antigen combination.

### FIELD OF THE INVENTION

The present invention relates to a method and apparatus for detection of substances, in particular biological agents, and more particularly biological molecules. In particular embodiments, the invention relates to a method and apparatus for detection of nucleic acids, or for detection of antigens or antibodies. Certain aspects of the invention relate to the use of attenuated total internal reflection to detect substances.

### BACKGROUND TO THE INVENTION

Several methods of detecting biological molecules, such as nucleic acids or antibodies, are known. For example, DNA can be detected and analysed by means of the polymerase chain reaction (PCR) to amplify specific sequences; or by hybridising a target strand to a detection strand, with subsequent detection of hybridisation by use of fluorophores or similar. The presence of antibodies to a particular antigen in a sample may be detected by the use of ELISA (Enzyme-Linked ImmunoSorbent Assay) or similar assays. However, these methods typically take some time to perform (for example, PCR amplification of DNA requires many cycles of amplification to be carried out, while ELISA may require time for the enzymatic activity to develop). The development of alternative methods of detection of biological molecules would be advantageous.

Evanescent wave techniques, such as evanescent wave cavity ring down spectroscopy (e-CRDS), are described in our earlier patent application WO04/068123, the contents of which are incorporated herein by reference. In brief, total internal reflection of a light beam within a medium, such as an optical fibre or other wave-guide, can be carried out in such a way that a non-propagating wave, called an evanescent wave, is formed at the interface at which total internal reflection occurs. This wave penetrates the medium surrounding the optical fibre, and can be used to impart some energy to a molecule adjacent the optical fibre surface. The loss of energy from the light beam within the fibre results in what has been termed attenuated total internal reflection (ATIR).

The present invention permits the application of ATIR to the detection of substances, such as biological agents, in particular biological molecules or micro-organisms. In certain embodiments, the detection is improved by the use of e-CRDS, but this is not an essential feature of the invention.

### SUMMARY OF THE INVENTION

According to a first aspect of the present invention, there is provided a method for detecting a substance, the method comprising:
providing a material within which light can undergo attenuated total internal reflection (ATIR), the material having a first agent which is a ligand for a substance to be detected located adjacent an external surface thereof;
contacting the external surface of the material with a sample to be tested, under conditions such that a substance to be detected within the sample will, if present, bind to the first agent;
transmitting electromagnetic radiation within the material, such that ATIR occurs; and
detecting any substances bound to the first agent, by a change in electromagnetic radiation transmitted within, or produced adjacent, the material.

The electromagnetic radiation is preferably visible light. The light may be produced by a laser.

Thus the present invention allows substances, preferably biological agents, such as biological molecules or micro-organisms, to be detected by causing such substances to bind to a ligand located adjacent the external surface of a material, such as an optical fibre. Binding is preferably selective for the substance to be detected. Binding of the substance causes a change in the amount of light being transmitted within the fibre, as the bound substance will absorb some of the energy from the transmitted light by the action of ATIR. Alternatively, the absorbed energy may be detected by its effect on a chromophore or similar moiety provided on the bound substance; for example, the chromophore could be induced to emit light which can itself then be detected. A further variation makes use of enzymatic, metabolic, or catalytic properties of such substances: for example, an enzyme-substrate binding reaction may be detected by the generation of a product having specific optical characteristics. Alternatively an antigen-antibody binding reaction may be detected using antibodies coupled to suitable enzymes such that addition of a substrate for the enzyme will lead to generation of a detectable product. Similarly, micro-organisms may be detected by metabolism of a substrate to produce a metabolite having detectable characteristics; a substrate may also be detected by metabolism by a micro-organism, which takes the role of the first agent. Instead of, or in addition to, detection of a specific product, a change in optical characteristics caused by the digestion, cleavage or the like of an existing substrate which itself is optically detectable.

The substance to be detected may comprise a biological agent, preferably a biological molecule; for example, nucleic acids, peptides, hormones, enzymes, substrates, antigens, antibodies, and so forth. Alternatively the agent may comprise a micro-organism; typically for detection of a micro-organism a specific biological molecule on the surface of the micro-organism will in fact be detected, for example a cell surface receptor or the like. Detection of a micro-organism may use alternate routes, however, for example detection of metabolic activity or enzymatic activity.

The first agent may be attached to the surface; alternatively the agent may not be attached, but may simply be held adjacent the surface. For example, the agent may be embedded in a matrix, such as a gel matrix e.g. agar. This is particularly useful when micro-organisms are used as the first agent, since the matrix may further be impregnated with nutrients, antibiotics, or other factors useful in the growth of such micro-organisms. The first agent may be a molecular agent, or may be a larger agent such as a micro-organism.

The step of detecting may comprise detecting a change in the optical profile (for example, intensity) of electromagnetic radiation transmitted within the material.

In certain embodiments, the step of detecting may comprise detecting the effect of electromagnetic radiation transmitted within the material on a moiety external to the material. The moiety may be a fluorophore, chromophore, or the like. The moiety may be provided on the substance to be detected (for example, a fluorescent label may be attached to a DNA strand to be detected). Alternatively the moiety may be provided on a third agent which itself binds, preferably selectively, to the substance to be detected. For example, where the first agent is a ligand, and the substance to be detected is an antibody, the third agent may be a fluorescently labelled antibody which binds the substance. Other means of targeting a fluorescent or otherwise detectable label to a substance are known to the skilled person, and may be used; for example, biotin—avidin and so forth. A further variation may use a chromophore or other label which detects an interacting portion of the first agent and the substance to be detected. For example, double-stranded DNA, such as may be obtained when a single stranded target sequence binds to a single stranded first molecule, can be detected using an intercalating agent which binds only to double stranded DNA; for example, ethidium bromide or DAPI. Other detection means include detection of an enzyme activity or a metabolic activity, for example as described above. Enzyme activity may be used directly to detect either an enzyme or a substrate for the enzyme; or may be used indirectly with the enzyme or substrate being used as a label which is then detected by addition of the appropriate substrate or enzyme to the label.

The first agent, the substance, and the third agent, if present, may be any suitable ligand/binding substance combination. For example, the first agent and the substance to be detected may both be nucleic acids, such as DNA, RNA, PNA or the like; they may be an antibody/antigen combination, or a target/receptor combination. The first agent and the substance to be detected may be an enzyme/substrate or micro-organism/substrate combination. The third agent will depend on the substance to be detected; the skilled person will be able to select an appropriate agent.

As a specific example, the first agent may be single stranded DNA with at least a portion complementary to at least a portion of a single stranded target DNA molecule to be detected. A third single stranded portion of DNA complementary to a further portion of the molecule to be detected may be conjugated to one or more chromophores. The target molecule will hybridise to the first molecule, and the third molecule will hybridise to the target molecule, such that all three strands are retained adjacent the optical fibre or other medium. The presence of the chromophore may then be detected, either by direct fluorescence, or by its effect on transmission of light within the optical fibre.

An alternative example may use an antibody to a bacterial cell surface antigen as the first agent. Bacteria displaying the antigen will bind to the antibody, while the third agent may be the same or an additional antibody to the antigen conjugated to a chromophore. This has the advantage that typically multiple antibodies will bind to a single bacterium, since multiple antigen molecules will be present; in this way the signal from the bacterium can be amplified. In a further variation the third agent may be an antibody conjugated to an enzyme; addition of the enzyme substrate will cause the formation of an optically detectable signal as the substrate is metabolised by the enzyme. A similar arrangement may be used to detect an enzyme substrate directly.

The material may be any suitable material; for example, glass, plastic, or the like. The material may be in the form of a prism, but is preferably in the form of an optical fibre, and more preferably a plastic optical fibre. Examples of suitable materials, and their preparation, are given in our international patent application PCT/GB2005/050203. The skilled person will be aware of other suitable materials. Different materials may have different light transmission profiles, such that the preferred wavelength of light to be used may be selected depending on the particular material used. A preferred method of preparing an optical fibre is to taper a section of a conventional optical fibre in order to expose a portion of the fibre allowing an evanescent wave to be generated. Alternative methods may be used.

The method may further comprise the step of reflecting light transmitted within the material such that light passes at least once through the material; preferably two or more passes. Such reflection allows the use of e-CRDS, but this feature is not essential, as we believe that satisfactory results may be obtained using the method with a single pass of light.

The method may further comprise the step of attaching the first agent to the external surface of the material.

The conditions under which the contacting of the external surface of the material with the sample to be tested is carried out will depend on the nature of the substance to be detected. The method may further comprise the step of washing or otherwise removing unbound substance from the first agent; likewise, a washing step may be carried out where a third agent is used in the method.

For example, where DNA is to be detected, such contacting may be carried out under conventional stringency conditions for DNA hybridisation. For example, a low stringency hybridisation may be a hybridisation and/or a wash carried out in 6×SSC buffer, 0.1% (w/v) SDS at 28° C. A moderate stringency hybridisation may be a hybridisation and/or washing carried out in 2×SSC buffer, 0.1% (w/v) SDS at a temperature in the range 45° C. to 65° C. A high stringency hybridisation may be a hybridisation and/or wash carried out in 0.1×SSC buffer, 0.1% (w/v) SDS at a temperature of at least 65° C. Where the DNA to be detected is identical to the DNA attached to the medium, high stringency conditions may be used; where the sequences are not identical, medium or low stringency conditions may be used. Variation in the temperature of the reaction may affect hybridisation, or may permit melting of hybridised double stranded DNA to release single strands. These temperature related events may in themselves provide useful information on the specificity of the identification of a sample DNA

Similarly, where an antibody is to be detected by binding to an antigen, or vice versa, suitable binding and washing conditions will be known to those of skill in the art. The precise conditions for any binding or washing may be optimised by routine experimentation by those skilled in the art.

According to a further aspect of the present invention, there is provided a method of detecting a nucleic acid sequence within a sample, the method comprising
providing a material within which electromagnetic radiation, preferably light, can undergo attenuated total internal reflection (ATIR), the material having a first nucleic acid molecule located adjacent an external surface thereof, at least a portion of the sequence of which is complementary to at least a portion of the sequence to be detected;
contacting the external surface of the material with a sample to be tested, under conditions such that a nucleic acid molecule to be detected within the sample will, if present, hybridise to the first nucleic acid molecule at least over the complementary portions thereof;
transmitting electromagnetic radiation within the material, such that ATIR occurs; and
detecting any nucleic acid molecules hybridised to the first nucleic acid molecules, by a change in electromagnetic radiation transmitted within, or produced adjacent, the material.

The nucleic acid molecule to be detected may comprise a label; for example a chromophore. The method may comprise the step of introducing a label to the nucleic acid molecule to be detected; for example, by a modified PCR technique. The label may alternatively be an enzyme, for example, horse radish peroxidase.

The nucleic acids may be DNA, RNA, PNA, or other modified nucleic acids. The nucleic acids need not be the same; for example, RNA may hybridise to DNA under certain conditions.

A label which recognises hybridised portions of the first nucleic acid molecule and the nucleic acid molecule to be detected may be contacted with the hybridised nucleic acid molecules. For example, dyes such as DAPI or ethidium bromide which intercalate within double stranded DNA may be used.

The method may further comprise the step of washing unhybridised sample or nucleic acid molecules from the first nucleic acid molecules.

The method may further comprise contacting the hybridised nucleic acid molecule to be detected with a third nucleic acid molecule having a sequence at least a portion of which is complementary to at least a further portion of the nucleic acid molecule to be detected, under conditions such that a nucleic acid molecule to be detected within the sample will, if present, hybridise to the third nucleic acid molecule at least over the complementary portions thereof. The portions of the nucleic acid molecule to be detected which are complementary to the first and third nucleic acid molecules respectively are different. The third nucleic acid molecule may comprise a label, for example a chromophore.

A further aspect of the present invention provides a method of detecting an antibody or antigen within a sample, the method comprising
providing a material within which light can undergo attenuated total internal reflection (ATIR), the material having an antibody or antigen located adjacent an external surface thereof, the antibody or antigen being specific for the antigen or antibody to be detected;
contacting the external surface of the material with a sample to be tested, under conditions such that an antigen or antibody to be detected within the sample will, if present, bind to the attached antibody or antigen;
transmitting electromagnetic radiation within the material, such that ATIR occurs; and
detecting any antigen or antibody bound to the attached antibody or antigen, by a change in electromagnetic radiation transmitted within, or produced adjacent, the material.

The antibody or antigen to be detected may comprise a label; for example a chromophore, an enzyme, or the like. The method may comprise the step of introducing a label to the antibody or antigen to be detected. Alternatively, the method may comprise the step of contacting the bound antigen or antibody with a labelled antibody specific for the bound antigen or antibody.

A further aspect of the present invention provides a method of detecting a substance within a sample, the method comprising
providing a material within which light can undergo attenuated total internal reflection (ATIR), the material having a micro-organism located adjacent an external surface thereof, the metabolism of the micro-organism being capable of being affected by the substance to be detected;
contacting the external surface of the material with a sample to be tested, under conditions such that a substance to be detected within the sample will, if present, affect the metabolism of the micro-organism;
transmitting electromagnetic radiation within the material, such that ATIR occurs; and
detecting any affect on the metabolism of the micro-organism, by a change in electromagnetic radiation transmitted within, or produced adjacent, the material.

The metabolism of the micro-organism may be affected by the substance in any suitable way; for example, by altering the growth rate; by metabolising the substance to generate a detectable metabolite; or so forth.

According to a further aspect of the present invention, there is provided an apparatus for detecting substances, the apparatus comprising a source of electromagnetic radiation; a material within which light can undergo attenuated total internal reflection (ATIR), the material having a first agent which is a ligand for a substance to be detected located adjacent an external surface thereof; and an electromagnetic radiation detector; the source being coupled to the material such that radiation is transmitted within the material and undergoes AITR, and the detector being arranged either to detect radiation transmitted within the material, or electromagnetic radiation produced adjacent the material.

The substance to be detected is preferably a biological agent, for example a biological molecule or a micro-organism.

The apparatus may further comprise one or more reservoirs or chambers for reagents; for example, a sample within which substances are to be detected; hybridisation and/or washing reagents appropriate for the substance to be detected; labels or labelled agents or molecules for binding to the substance to be detected. The apparatus may further comprise a reaction chamber within which the material is located, with the reservoirs being coupled to the reaction chamber to allow movement of reagents from the reservoirs to the reaction chamber. The reaction chamber may also be controlled with respect to physical parameters, such as temperature.

A further aspect of the invention provides an apparatus for detecting substances, preferably biological agents, more preferably biological molecules, the apparatus comprising a source of electromagnetic radiation; a chamber for receiving a material within which light can undergo attenuated total internal reflection (ATIR), the material having a first agent which is a ligand for a substance to be detected located adjacent an external surface thereof; and an electromagnetic radiation detector; the source arranged to be coupled to the material such that radiation is transmitted within the material and undergoes AITR, and the detector being arranged either to detect radiation transmitted within the material, or electromagnetic radiation produced adjacent the material.

A still further aspect of the invention provides a module for an apparatus for detecting substances, the module comprising a material within which light can undergo attenuated total internal reflection (ATIR), the material having a first agent which is a ligand for a substance to be detected located adjacent an external surface thereof. The material may be contained within a reaction chamber. The module may further comprise one or more reagent reservoirs for containing reagents for use in the detection of substances. The module is conveniently in a ‘lab-on-a-chip’ form; that is, the module is arranged to permit the use of microfluidics to transfer reagents to and from the material. For example, a module may be around the size and shape of a credit card, and have an optical fibre extending along the length of the module. Reservoirs may be located around the periphery of the module, and coupled to the optical fibre by microfluidics channels. Such a module may conveniently be fitted to or removed from an apparatus as described above; this allows ready and rapid use of the apparatus and the method described herein for detection of a range of different substances.

A further aspect of the present invention provides a kit for use in detection of substances, the kit comprising a plurality of modules as described herein.

A yet further aspect of the present invention provides a method of making a sensor for detection of substances, the method comprising providing a material within which light can undergo attenuated total internal reflection (ATIR), and locating a first agent which is a ligand for a substance to be detected adjacent an external surface thereof.

The material may be in the form of an optical fibre. The step of locating the agent may comprise attaching the agent to the surface, preferably further comprising the step of treating the external surface of the material to make it suitable for such attachment; for example, where the material is glass, the material may be silanated to allow attachment of nucleic acid molecules via a further linking molecule which reacts with both silane and nucleic acids. Proteins or peptides, such as antibodies or antigens, may be linked to a silanated optical fibre surface, either glass or plastic, by a diisothiocyanate linkage. Non-covalent attachments may be used; for example, streptavidin may be covalently or otherwise attached to the surface, and biotinylated nucleic acids attached via the streptavidin. Alternatively the agent may be located adjacent the surface for example by embedding the agent in a matrix such as a gel matrix. The skilled person will be aware of other methods whereby molecules may be attached to particular materials.

The method may further comprise the step of adapting a material such that light within it can undergo ATIR; for example, a conventional optical fibre may have a portion of the coating removed to permit ATIR.

### BRIEF DESCRIPTION OF THE DRAWINGS

These and other aspects of the present invention will now be described by way of example only and with reference to the accompanying figures, in which:

FIG. 1a shows a cavity 10 of a gas phase Cavity Ring-Down Spectroscopy (CRDS) device.

FIG. 1b shows the concepts underlying evanescent wave CRDS (e-CRDS).

FIGS. 2a and 2b show ways in which access to the optical elements of an optical fibre may be provided.

FIG. 3 shows the results of a test conducted to determine whether an amine-terminated oligonucleotide could be linked to an aminated silica surface via a diisothiocyanate tether.

FIG. 4 shows the results of an experiment confirming that the dye Alexafluor 647 can be attached to a plastic optical fibre.

FIG. 5 shows the results of an experiment confirming that the dye Bromothymol Blue can be bonded to a POF.

FIG. 6 shows that receptor DNA can be attached to a surface.

FIG. 7 shows sample results obtained from DNA detection experiments carried out with a plastic optical fibre.

FIG. 8 shows the general schematic arrangement of the detection system of the present invention.

FIG. 9 shows the experimental scheme for detecting DNA sequences.

FIG. 10 shows a schematic of a detection method for antigens such as bacteria in a sample.

FIG. 11 shows an alternative method of detecting micro-organism substrates in a sample.

FIG. 12 shows a schematic of a detection method for detecting radioactive labels.

FIG. 13 shows an example of an apparatus for detecting substances in accordance with an embodiment of the present invention.

FIG. 14 shows a further example of an apparatus for detecting substances.

FIG. 15 shows sample results obtained with the apparatus of FIG. 14.

### DETAILED DESCRIPTION OF THE DRAWINGS

The techniques we describe here are enhanced in their sensitivity, for some applications, by the use of Cavity Ring-Down Spectroscopy (CRDS), and hence it is helpful to outline this technique. However it is important to understand that the use of CRDS, or of multiple passes of a light pulse back and forth within a cavity is not essential.

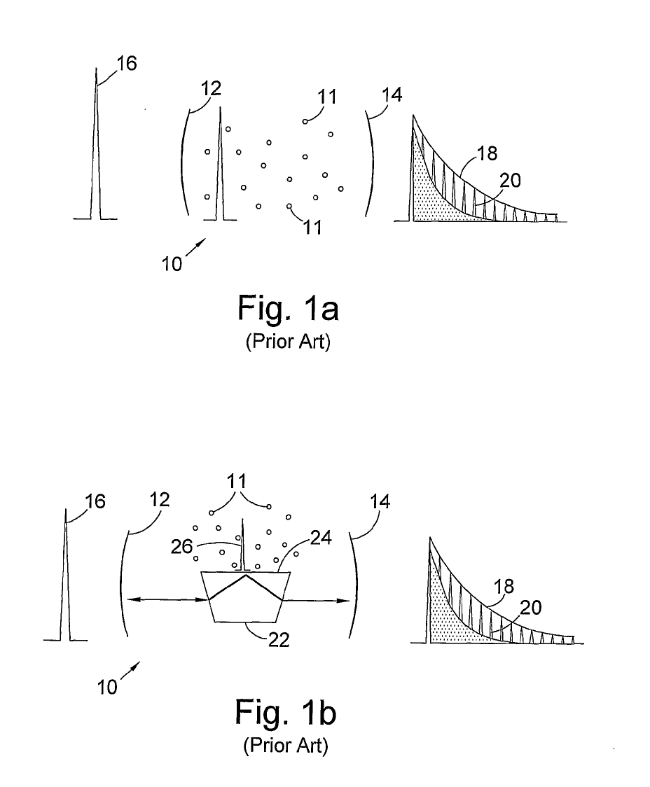

FIG. 1a, which shows a cavity 10 of a gas phase Cavity Ring-Down Spectroscopy (CRDS) device, illustrates the main principles of the technique. The cavity 10 is formed by a pair of high reflectivity mirrors at 12, 14 positioned opposite one another (or in some other configuration) to form an optical cavity or resonator. A pulse of laser light 16 enters the cavity through the back of one mirror (mirror 12 in FIG. 1a) and makes many bounces between the mirrors, losing some intensity at each reflection. Light leaks out through the mirrors at each bounce and the intensity of light in the cavity decays exponentially to zero with a half-life decay time, T. The light leaking from one or other mirror, in FIG. 1a preferably mirror 14, is detected by a photo multiplier tube (PMT) as a decay profile such as decay profile 18 (although the individual bounces are not normally resolved). Curve 18 of FIG. 1a illustrates the origin of the phrase “ring-down”, the light ringing backwards and forwards between the two mirrors and gradually decreasing in amplitude. The decay time T is a measure of all the losses in the cavity, and when molecules 11 which absorb the laser radiation are present in the cavity the losses are greater and the decay time is shorter, as illustratively shown by trace 20.

Since the pulse of laser radiation makes many passes through the cavity even a low concentration of absorbing molecules (or atoms, ions or other species) can have a significant effect on the decay time. The change in decay time, ΔT, is a function of the strength of absorption of the molecule at the frequency, v, of interest α (v) (the molecular extinction coefficient) and of the concentration per unit length, ls, of the absorbing species and is given by equation 1 below

ΔT=tr/{2(1−R)+α(v)ls} (1)

where R is the reflectivity of each of mirrors 12, 14 and tr is the round trip time of the cavity, tr=c/2L where c is the speed of light and L is the length of the cavity. Since the molecular absorption coefficient is a property of the target molecule, once ΔT has been measured the concentration of molecules within the cavity can be determined without the need for calibration. Since the decay times are generally relatively short, of the order of tens of nanoseconds, a timing calibration may be needed; this may be performed when the apparatus is initially set up.

For CRDS it is desirable to have total losses less than 0.25%, corresponding to around 200 bounces during decay time T, or approximately 1000 bounces during ring down of the entire cavity—if the total losses in the cavity are say around 1% there will only be 3 or 4 bounces and consequently the sensitivity of the apparatus is reduced. However for embodiments of the apparatus and methods we describe a single or double pass in a cavity is sufficient for some applications.

The basic CRDS technique is only suitable for sensing molecules that are introduced into the cavity in a gas but we have previously described, in WO04/068123 (hereby incorporated by reference in its entirety), evanescent wave CRDS (e-CRDS) can be employed to overcome this problem. Background prior art relating to e-CRDS can be found in U.S. Pat. No. 5,943,136, U.S. Pat. No. 5,835,231 and U.S. Pat. No. 5,986,768.

FIG. 1b, in which like elements to those of FIG. 1a are indicated by like reference numerals, shows the idea underlying evanescent wave CRDS. In FIG. 1b a prism 22 (as shown, a pellin broca prism) is introduced into the cavity such that total internal reflection (TIR) occurs at surface 24 of the prism (in some arrangements a monolithic cavity resonator may be employed). Total internal reflection will be familiar to the skilled person, and occurs when the angle of incidence (to a normal surface) is greater than a critical angle θc where sin θc is equal to n2/n1 where n2 is the refracted index of the medium outside the prism and n1 is the refractive index of the material of which the prism is composed. Beyond this critical angle light is reflected from the interface with substantially 100% efficiency back into the medium of the prism, but a non-propagating wave, called an evanescent wave (e-wave) is formed beyond the interface at which the TIR occurs. This e-wave penetrates into the medium above the prism but its intensity decreases exponentially with distance from the surface, typically over a distance of the order of the a wavelength. The depth at which the intensity of the e-wave falls to 1/e (where e=2.718) of its initial value is known at the penetration depth of the e-wave. For example, for a silica/air interface under 630 nm illumination the penetration depth is approximately 175 nm and for a silica/water interface the depth is approximately 250 nm, which may be compared with the size of a molecule, typically in the range 0.1-1.0 nm.

A molecule adjacent surface 24 and within the e-wave field can absorb energy from the e-wave illustrated by peak 26, thus, in effect, absorbing energy from the cavity. In such circumstances the “total internal reflection” is sometimes referred to as attenuated total internal reflection (ATIR). As with the conventional CRDS apparatus a loss in the cavity is detected as a change in cavity ring-down decay time, and in this way the technique can be extended to measurements on molecules in a liquid or solid phase as well as molecules to in a gaseous phase. In the configuration of FIG. 1b molecules near the total internal reflection surface 24 are effectively in optical contact with the cavity, and are sampled by the e-wave resulting from the total internal reflection at the surface.

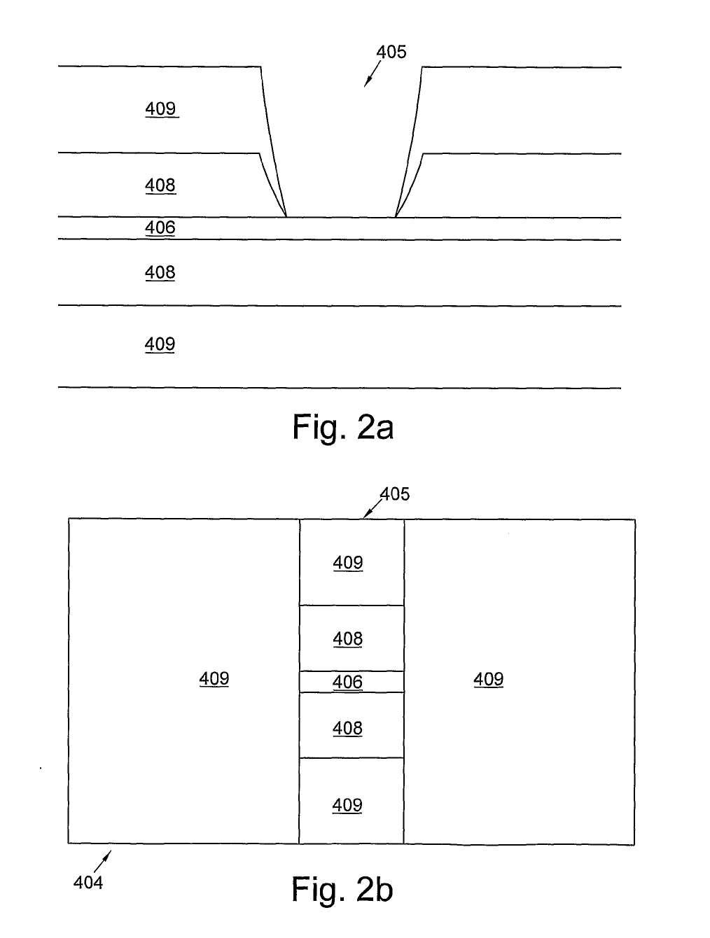

To utilize a fibre optic cavity as a sensor of an e-CRDS or other evanescent wave based instrument access to an evanescent wave guided within the fibre is needed. FIGS. 2a and 2b show one way in which such access may be provided; others will be known to the skilled person. Broadly speaking a portion of cladding is removed from a short length of the fibre to expose the core or more particularly to allow access to the evanescent wave of light guided in the core by, for example, a substance to be sensed.

FIG. 2a shows a longitudinal cross section through a sensor portion 405 of the fibre optic cable 404 and FIG. 2b shows a view from above of a part of the length of fibre optic cable 404 again showing sensor portion 405. The fibre optic cable comprises an inner core 406, typically around 5 μm in diameter for a single mode fibre, surrounded by a glass cladding 408 of lower refractive index around the core, the cable also generally being mechanically protected by a casing 409, for example comprising silicon rubber and optionally armour. The total cable diameter is typically around 1 mm and the sensor portion may be of the order of 1 cm in length. As can been seen at the sensor portion of the cable the cladding 408 is at least partially removed to expose the core and hence to permit access to the evanescent wave from guided light within the core. The thickness of the cladding is typically 100 μm or more, but the cladding need not be entirely removed although preferably less than 10 μm thickness cladding is left at the sensor portion of the cable. It will be appreciated that there is no specific restriction on the length of the sensor portion although it should be short enough to ensure that losses are kept well under one percent. It will be recognized that, if desired, multiple sensor portions may be provided on a single cable.

A sensor portion 405 on a fibre optic cable may be created either by mechanical removal of the casing 409 and portion of the cladding 408 or by chemical etching. For example in a mechanical removal process the fibre optic cable is passed over a rotating grinding wheel (with a relatively fine grain) which, over a period of some minutes, mechanically removes the casing 409 and cladding 408. The point at which the core 406 is optically exposed may be monitored using a laser injecting light into the cable which is guided to a detector where the received intensity is monitored. Refractive index matching fluid is provided at the contact point, this having a higher refractive index than the core so that when the core is exposed light is coupled out of the cable and the detected intensity falls to zero.

Once the optical fibre has been prepared, molecules must be attached to the optically exposed portion of the surface to allow binding of the biological molecules to be detected. Depending on the material from which the optical fibre is made, and depending on the molecules to be attached, the surface may need to be treated to allow attachment.

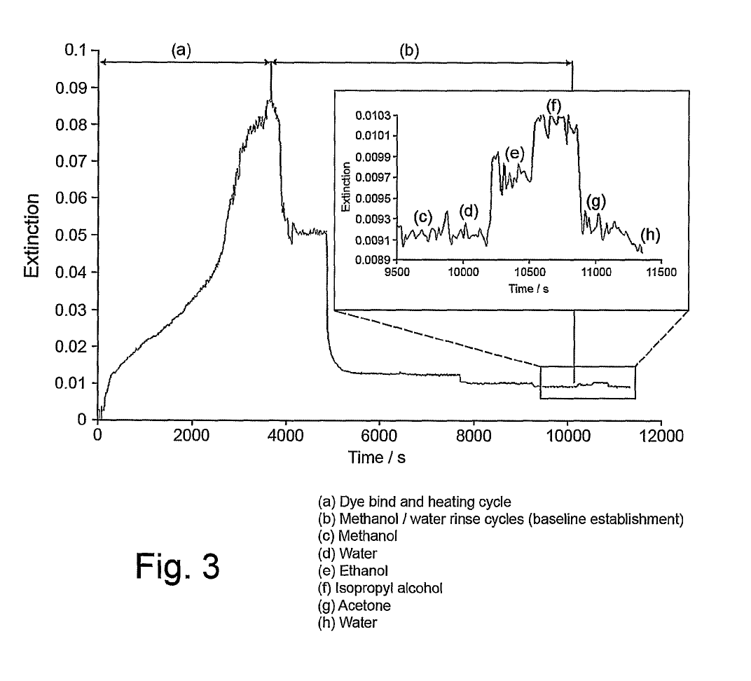

FIG. 3 shows the results of a test conducted to determine whether an amine-terminated oligonucleotide could be linked to an aminated silica surface via a diisothiocyanate tether. Interrogation of such a surface could be accomplished with our evanescent wave cavity ring down spectroscopy (e-CRDS) technology. The first trials have utilised a more aggressive solvent system and harsher conditions than which we would intend to employ in a production environment as the materials under test are suitable for withstanding such conditions.

Tethering Steps Reaction Conditions. A silica prism surface was exposed to a solution of 3-aminopropyltriethoxysilane in methanol (10% v/v) for 1 hour followed by air drying at 80° C. for 1 hour. The resulting surface was then reacted with p-phenylene diisothiocyanate in dimethyl formamide (2 mM) for 1 hour at 80° C. An amine group-containing blue dye (Brilliant Cresyl Blue) was then applied from a 100 mM aqueous solution in the e-CRDS rig flow cell. The flow cell and prism were heated to a temperature in excess of 80° C. for 1 hour.

The amine-terminated dye was seen to bind successfully to an aminated/diisothiocyanated silica surface. Confirmation of the bind was indicated by e-CRDS signal shifts with solvent type which were not consistent with solvent refractive index; solvato-chromic shifts at the dyed surface giving different extinction changes from those expected with the variation of the refractive indices of the solvents tested. The potential for application of this tethering route to the immobilisation of oligonucleotides on silica surfaces in e-CRDS exists.

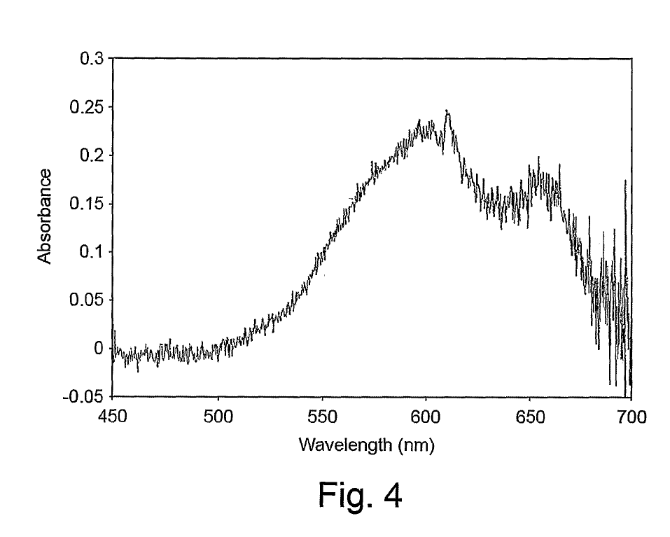

FIG. 4 shows the results of an experiment confirming that the dye Alexafluor 647 can be attached to a plastic optical fibre. A stripped POF Fibre surface was treated with aminopropyl triethoxysilane, after which the succinimidyl ester derivative of Alexafluor 647 was reacted onto prepared aminated surface. A repeatable absorbance spectrum was recorded on several POF fibres. Control experiments using octyltriethoxysilane and bare stripped fibre confirmed that the reaction only occurs at aminated surface.

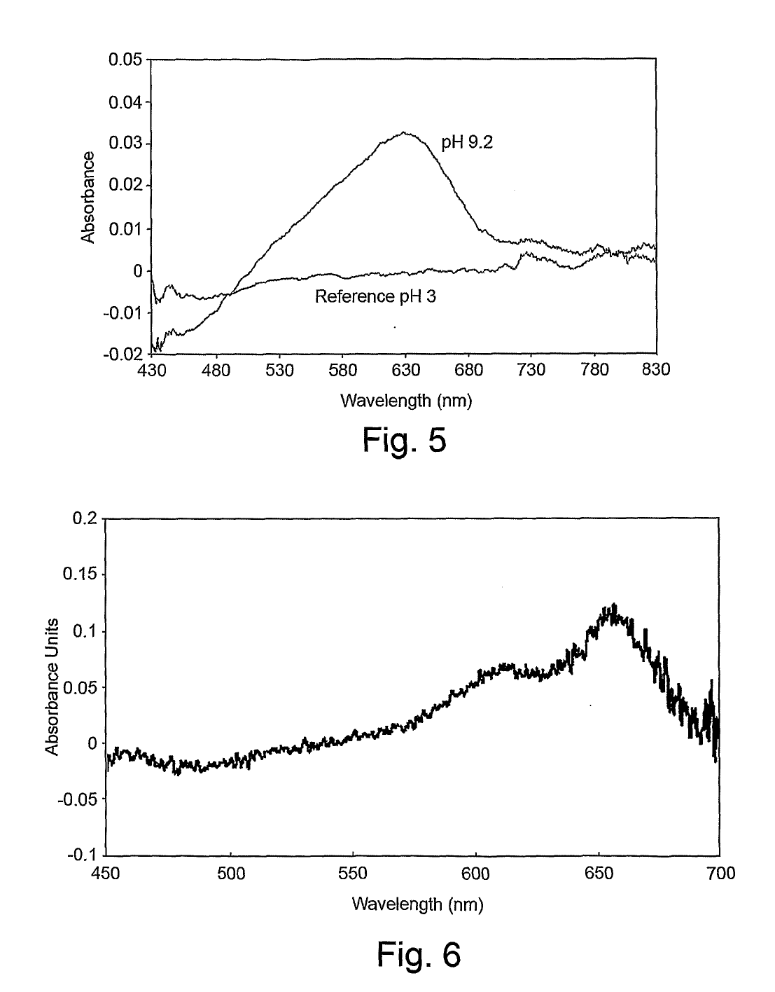

FIG. 5 shows the results of an experiment confirming that the dye Bromothymol Blue can be bonded to a POF. A stripped POF Fibre surface was treated with aminopropyl triethoxysilane, after which a linker molecule (phenylene diisothiocyanate) was applied from 2 mM solution in DMF. Bromothymol blue was applied from solution in DMF. Control tapers broke instantly on exposure to DMF suggesting that silanation has improved the chemical resistance of the fibre.

DNA binding experiments were conducted using 30 base pair DNA sequences (oligomers) of MRSA. The results of these are shown in FIG. 6. The sequences used were: receptor sequence with reactive tag for binding to surface (Oligo 1A); complementary sequence with AlexaFluor 647 tag to test ability to detect DNA hybridisation (Oligo 3A); and nonsense sequence with AlexaFluor 647 tag to act as control (Oligo 4A). FIG. 6 shows that we successfully attached receptor DNA to surface. Other data confirms that we can detect binding of tagged DNA (specific & non-specific binding) to receptor surface in both single pass and e-CRDS.

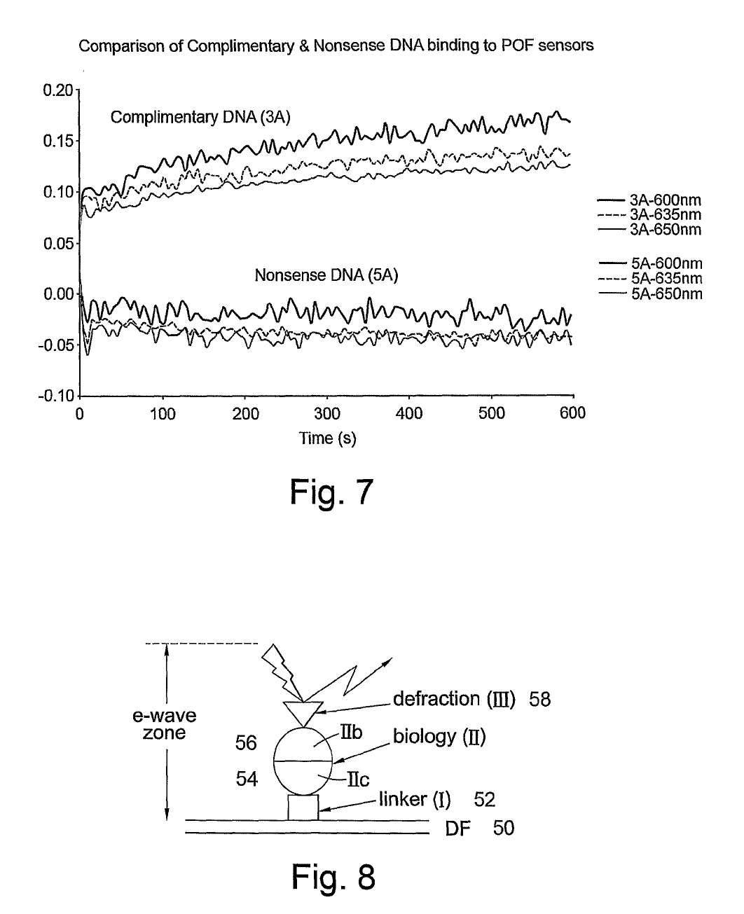

DNA binding and detection experiments were conducted using 30 base pair DNA sequences (oligomers) of MRSA and plastic optical fibre (POF) with single pass detection at several detection wavelengths. The results of these are shown in FIG. 7. The sequences used were: receptor sequence with reactive tag for binding to surface (Oligo 1A, as before); complementary sequence with AlexaFluor 647 tag to test ability to detect DNA hybridisation (Oligo 3A, as before); and nonsense sequence with AlexaFluor 647 tag to act as control (Oligo 5A). In the experiment shown in FIG. 7, the receptor DNA (Oligo 1A) was attached to the tapered surface region of a POF as follows.

A stripped (cladding removed) POF taper was dipped into a 10% solution of aminopropyl triethoxy silane in ethanol for 5 minutes. The taper was removed and placed in an oven at 80° C. to “cure” the silane onto the fibre surface. The amino silane surface was then reacted with an aqueous solution of disuccinimidyl carbonate for 1 hour at room temperature. The receptor DNA was then reacted onto the succinimidyl ester group remaining on the surface.

This probe was then dipped into a solution of 400 nM Oligo 3A and the hybridisation between the receptor and the target DNA monitored by changing absorbance at the three wavelengths shown. In a separate experiment another receptor DNA-POF probe was dipped into a solution of 400 nM Oligo 5A. Since there was no complimentary relationship between the receptor and the target DNA single strands, there was no hybridisation to form a double stranded sequence, these being shown by no increase in absorbance.

FIG. 8 shows the general schematic concept of a detection system according to the present invention. An optical fibre 50 carries adjacent to or attached to the surface a first linker molecule 52. The linker 52 provides a means of attachment of a ligand 54 to the fibre 50, which may be covalent, H bonding, etc, or may be some form of matrix, for example agar. The ligand 54 specifically recognises a target 56, the target being the substance to be detected. Any ligand-target interaction which provides specific recognition may be used; for example antibody-antigen; DNA-DNA; enzyme substrate; or microbe-growth factor. Finally, a detector agent 58 may be present; this is not necessary if the ligand-target interaction itself can be directly detected via the optical fibre, but more generally may be a chromophore, fluorophore, radioactive label, enzyme, antibody, or the like. The detector agent may be detected via the optical fibre 50; for example, by detection of absorption of electromagnetic radiation from an evanescent wave within the optical fibre, or by detection within the optical fibre of photons emitted by the detector agent. An alternative means is the detection of scintillation within the optical fibre caused by the emission of radioactive particles from the detector agent. Alternatively, or in addition, the detector agent may be detected outside the optical fibre; for example, by the detection of emitted photons or radioactive particles from the detector agent. Typically the detector agent will be detected as a consequence of absorption of energy from an evanescent wave; alternatively the detector agent may be specifically stimulated by a different stimulus, such as external light of a specific wavelength or the like. Appropriate stimuli will depend on the nature of the detector agent.

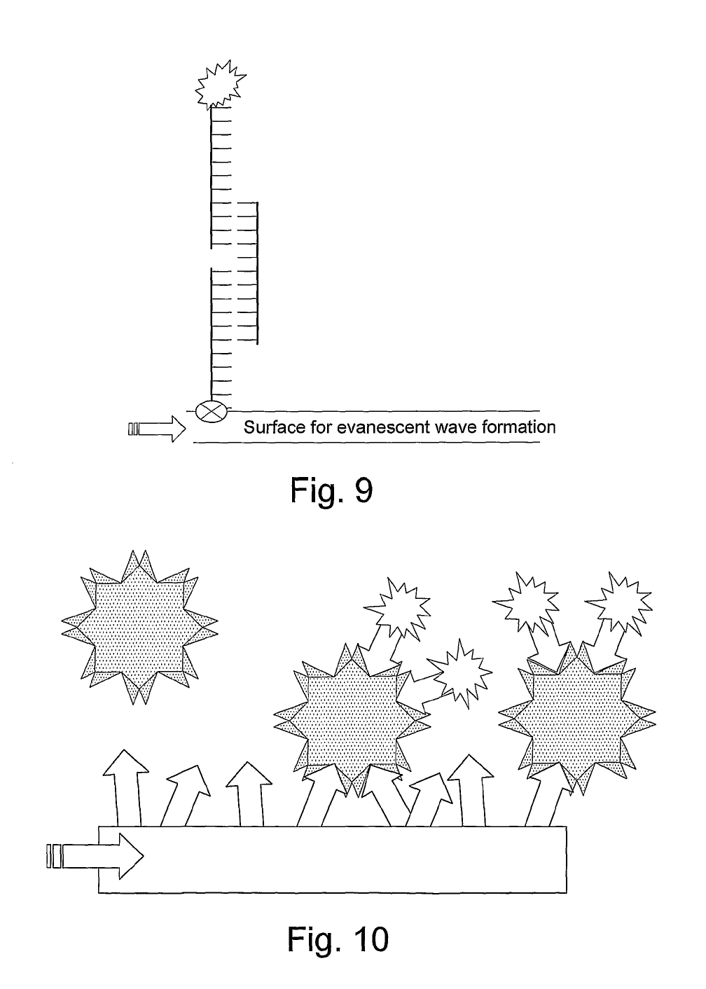

FIG. 9 shows the experimental scheme for detecting DNA sequences. A first oligonucleotide is attached to the surface of the optical fibre, with a portion of the oligonucleotide being complementary to a first portion of the sequence to be detected. Addition of the sample allows the sequence to be detected to hybridise to the first oligonucleotide. After removal of unhybridised molecules, a third oligonucleotide having a portion complementary to a remaining portion of the sequence to be detected is added and allowed to hybridise; the third oligonucleotide also carries a chromophore. After a further washing step, light is passed along the optical fibre; ATIF occurs, causing the chromophore to absorb energy from the evanescent wave. The absorbance may then be detected directly as a result of loss of ATIR energy. This allows the binding of the third oligonucleotide to be detected, and hence the presence of the second oligonucleotide. The detection may be carried out in real time; for example, light may be continuously passed along the fibre, and the change in transmission detected as it happens.

A variation makes use of a fluorophore rather than a chromophore on the third oligonucleotide. The fluorophore will either absorb energy from the evanescent wave, or may be stimulated by an external light source, and will fluoresce. The emitted photons may be passed back into the optical fibre, and can be detected as an increase in light energy within the fibre. Alternatively the emitted photons may be detected outside the fibre, before they pass into the fibre.

As an alternative strategy, the third oligonucleotide may not be used, and the second oligo itself is directly labelled. A further alternative is to use an enzyme label instead of the chromophore; the enzyme may digest a substrate to produce a detectable product. This results in amplification of the detection reaction since a single enzyme may metabolise multiple substrates.

FIG. 10 shows a schematic of a detection method for antigens such as bacteria in a sample. In this example, a number of antibodies specific for the antigen are attached to the optical fibre. A sample containing the antigen is added, and the antigen allowed to bind to the antibodies. A second, labelled antibody is then added; this binds to further exposed epitopes on the antigen; detection of the label is then carried out as before.

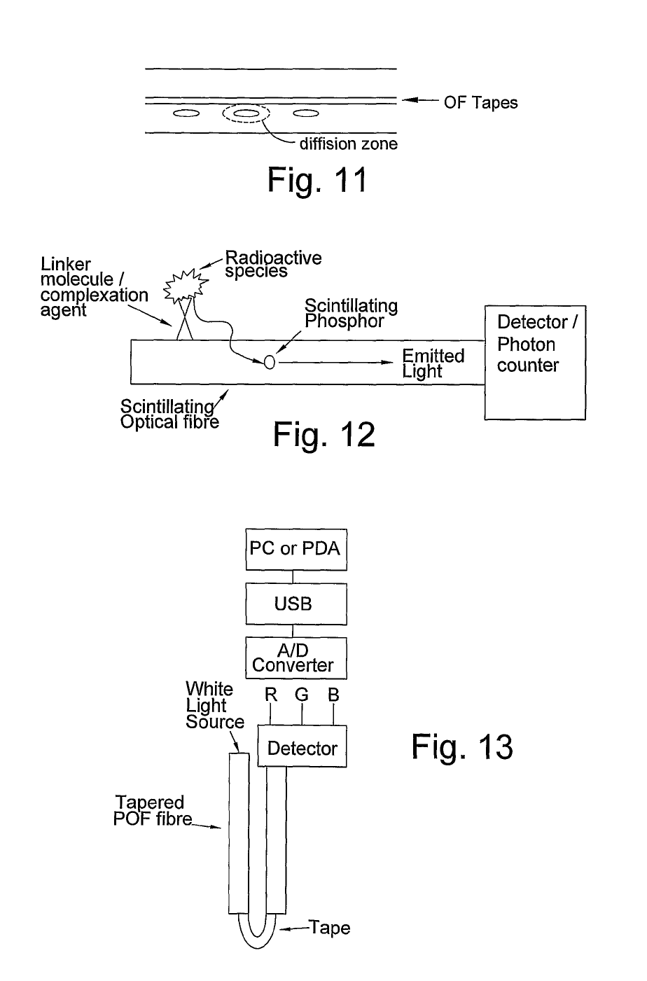

FIG. 11 shows a method involving the use of micro-organisms to detect substances. The micro-organisms grow as embedded colonies in agar located on the surface of an optical fibre. A substrate for the micro-organisms may be added to the agar, which is then metabolised to create a detectable product—for example, tetrazolium may be metabolised to give formazan, which can then be detected. The presence of substances which can affect this metabolism, for example, antibiotics, growth factors, or the like, in a test sample can then be detected.

FIG. 12 shows a method involving the detection of substances using radioactivity labels. The method may use either natural radioactivity or the incorporation of a radioactive label such as Carbon 14 or Iodine 125. The system uses a fibre optic (plastic or glass) that has had the core material doped with a scintillating phosphor that produces visible light when high energy particles such as radioactive emissions pass through the fibre. Thus, when a radioactive label is present the total energy of the light passing through the fibre will increase, and the bound label can be detected. The fibre may be tapered although we believe that this may not be necessary, and may be surface treated as previously described to enable binding of radioactive substances to the surface. This may include the use of complexation agents such as calix 6 arene to enable the detection of radioactive metal ions such as uranium or plutonium or radioactively labelled antibodies, antigens or nucleic acids for detection of biomolecules. The fibre may be mirrored at one end to enhance sensitivity. Multiple fibres may be used in a bundle, coil or loop to provide further sensitivity enhancements.

FIG. 13 shows a first embodiment of a detection system according to the present invention. The system uses the principles of ATIR to detect substances within the evanescent wave generated from an optical fibre, waveguide or similar. A typical system consists of a light source, preferably an LED, a tapered plastic optical fibre to act as the sensor, a broad spectral range detector and electronic communications via USB. The following points should be noted.
The tapered optical fibre can be plastic, glass or other material
The taper may be straight, bent or coiled (preferably bent up to 180° to give a bend radius of 3 mm or less)
The fibre cladding may be left intact or stripped away to expose the core material
The surface of the fibre may be treated by either silanation, UV exposure, plasma polymerisation or other chemical method to generate reactive functional groups on the surface such as but not limited to; OH, NH₂, COOH, NCO, NCS.
Chromophore, fluorophore or other indicator molecules may be attached to the surface to detect substances by reaction with the reactive functional groups using linker molecules including but not limited to disothiocyanates, diisocyanates, disuccinimidyl esters, diamines or dicarboxylic acids
The light source typically consists of a single white light LED with a broad spectral range between 400-700 nm although other wavelength ranges may also be used. A variation on the system consists of 2 or more LEDs co-packaged in a single surface mount device, the individual LEDs may be switched on or off to create the desired spectral profile.
The detector typically consists of an array of photodiodes/transistors individually coated to give selected wavelength response ranges. The example given uses a detector designed as a colour sensor and consisting of an array of 57 photodiodes in a hexagonal matrix coated to give 19 individual red, green and blue colour sensors. This detector permits simultaneous detection in 3 separate wavelength ranges (400-500, 500-600 and 600-700 nm).

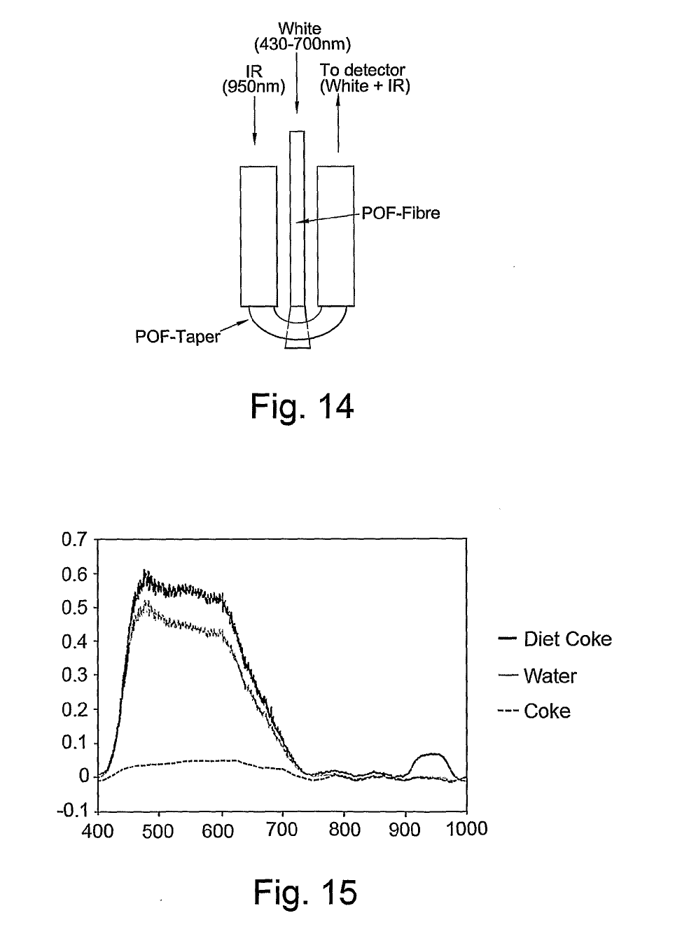

A variation of the system is shown in FIG. 14; this variation uses the ability of tapered multimode fibre to couple external light into the fibre. In the Figure the previously described system is modified to use IR light transmitted along the tapered optical fibre to measure refractive index of a substance and an external light source such as a white LED to measure the absorbance spectrum of the substance. The substance may be a fluid or gaseous medium or an absorbed substance on the surface of the fibre. The wavelength of light used for both transmission down the fibre and externally may be varied to suit the substance being investigated and may range from ultraviolet to near infrared. The external light source may be delivered by a second fibre, light guide or simply placed such that light emitted passes through the substance before falling onto the tapered region of the fibre. An example of the results obtained from use of this system is presented in FIG. 15; this figure demonstrates that the arrangement shown in FIG. 13 can generate useful data.

1-32. (canceled)

33. A method for detecting a substance, the method comprising:
providing a material within which light can undergo attenuated total internal reflection (ATIR), the material having a first agent which is a ligand for a substance to be detected located adjacent an external surface thereof;
contacting the external surface of the material with a sample to be tested, under conditions such that a substance to be detected within the sample will, if present, bind to the first agent;
transmitting electromagnetic radiation within the material, such that ATIR occurs; and
detecting any substances bound to the first agent, by a change in electromagnetic radiation transmitted within, or produced adjacent, the material.

34. The method of claim 33 wherein the electromagnetic radiation is visible light.

35. The method of claim 33 wherein the step of detecting comprises detecting a change in the profile of electromagnetic radiation transmitted within the material.

36. The method of claim 33 wherein the step of detecting comprises detecting the effect of electromagnetic radiation transmitted within the material on a moiety external to the material.

37. The method of claim 36 wherein the moiety is a fluorophore, chromophore, or the like.

38. The method of claim 36 wherein the moiety is provided on the substance to be detected.

39. The method of claim 36 wherein the moiety is provided on a third agent which itself binds to the substance to be detected.

40. The method of claim 36 wherein the moiety is a label which detects an interacting portion of the first agent and the substance to be detected.

41. The method of claim 33 wherein the first agent and the substance to be detected are both nucleic acids.

42. The method of claim 33 wherein the first agent and the substance to be detected are an antibody/antigen combination.

43. The method of claim 33 wherein the first agent and the substance to be detected are a target/receptor combination.

44. The method of claim 33 wherein the material is in the form of an optical fibre.

45. The method of claim 33 further comprising the step of reflecting light transmitted within the material such that light passes at least twice through the material.

46. The method of claim 33 further comprising the step of attaching the first agent to the external surface of the material.

47. The method of claim 33 further comprising the step of washing or otherwise removing unbound substance from the first agent.

48. A method of detecting a nucleic acid sequence within a sample, the method comprising:
providing a material within which electromagnetic radiation can undergo attenuated total internal reflection (ATIR), the material having a first nucleic acid molecule located adjacent an external surface thereof, at least a portion of the sequence of which is complementary to at least a portion of the sequence to be detected;
contacting the external surface of the material with a sample to be tested, under conditions such that a nucleic acid molecule to be detected within the sample will, if present, hybridise to the first nucleic acid molecule at least over the complementary portions thereof;
transmitting electromagnetic radiation within the material, such that ATIR occurs; and
detecting any nucleic acid molecules hybridised to the first nucleic acid molecules, by a change in electromagnetic radiation transmitted within, or produced adjacent, the material.

49. A method of detecting an antibody or antigen within a sample, the method comprising:
providing a material within which electromagnetic radiation can undergo attenuated total internal reflection (ATIR), the material having an antibody or antigen located adjacent an external surface thereof, the antibody or antigen being specific for the antigen or antibody to be detected;
contacting the external surface of the material with a sample to be tested, under conditions such that an antigen or antibody to be detected within the sample will, if present, bind to the attached antibody or antigen;
transmitting electromagnetic radiation within the material, such that ATIR occurs; and
detecting any antigen or antibody bound to the attached antibody or antigen, by a change in electromagnetic radiation transmitted within, or produced adjacent, the material.

50. An apparatus for detecting substances, the apparatus comprising:
a source of electromagnetic radiation;
a material within which electromagnetic radiation can undergo attenuated total internal reflection (ATIR), the material having a first agent which is a ligand for a substance to be detected located adjacent an external surface thereof; and
an electromagnetic radiation detector; the source being coupled to the material such that radiation is transmitted within the material and undergoes AITR, and the detector being arranged either to detect radiation transmitted within the material, or electromagnetic radiation produced adjacent the material.

51. The apparatus of claim 50 further comprising one or more reservoirs for reagents.

52. The apparatus of claim 51 wherein the reservoirs contain a sample within which substances are to be detected.

53. The apparatus of claim 51 wherein the reservoirs contain hybridisation and/or washing reagents appropriate for the substance to be detected.

54. The apparatus of claim 50 further comprising a reaction chamber within which the material is located.

55. The apparatus of claim 54 comprising one or more reservoirs coupled to the reaction chamber.

56. The apparatus of claim 54 wherein the reaction chamber is temperature controlled.

57. An apparatus for detecting substances, the apparatus comprising:
a source of electromagnetic radiation;
a chamber for receiving a material within which electromagnetic radiation can undergo attenuated total internal reflection (ATIR), the material having a first agent which is a ligand for a substance to be detected located adjacent an external surface thereof;
an electromagnetic radiation detector; and
the source arranged to be coupled to the material such that radiation is transmitted within the material and undergoes AITR, and the detector being arranged either to detect radiation transmitted within the material, or electromagnetic radiation produced adjacent the material.

58. A module for an apparatus for detecting substances, the module comprising a material within which electromagnetic radiation can undergo attenuated total internal reflection (ATIR), the material having a first agent which is a ligand for a substance to be detected located adjacent an external surface thereof.

59. The module of claim 58 further comprising one or more reagent reservoirs for containing reagents for use in the detection of substances.

60. A kit for use in detection of substances, the kit comprising a plurality of modules of claim 58.

61. A method of making a sensor for detection of substances, the method comprising providing a material within which electromagnetic radiation can undergo attenuated total internal reflection (ATIR), and locating a first agent which is a ligand for a substance to be detected adjacent an external surface thereof.

62. The method of claim 61 wherein the material is in the form of an optical fibre.

63. The method of claim 61 wherein the step of locating the agent comprises the step of attaching the agent to the surface.

64. The method of claim 61, further comprising the step of adapting a material such that light within it can undergo ATIR.
